(19) United States
(12) Patent Application Publication
(10) Pub. No.: US 2012/0302642 A1
(43) Pub. Date: Nov. 29, 2012

(54) Viscous Acidic Abrasive Cleaning Compositions

(75) Inventor: Sarah Marie Post, Garnerville, NY (US)

(73) Assignee: Reckitt Benckiser LLC, Parsippany, NJ (US)

(21) Appl. No.: 13/496,509

(22) PCT Filed: Sep. 9, 2010
(86) PCT No.: PCT/GB2010/051508

§ 371 Date: Aug. 6, 2012

(30) Foreign Application Priority Data
Sep. 30, 2009 (GB) 0917109.1

(51) Int. Cl. A01N 37/02; A01N 37/04; A01P 1/00; A01N 37/36

(52) U.S. Cl. 514/574; 514/557

(57) ABSTRACT

Aqueous acidic, abrasive hard surface cleaning composition comprising: about 0.5-3.5% wt. of a thickener system which includes both a colloid forming clay, preferably a montmorillonite clay, and a gum based thickener, preferably xantham gum; about 0.01-2.5% wt. of a surfactant selected from anionic surfactants, nonionic surfactants, and mixtures thereof; an antimicrobially effective amount of at least one organic acid present in an amount of from about 2-12% wt.; as an abrasive constituent, pumice, which may be present in an amount of at least about 5% wt.; optionally but preferably an opacifying/tinting constituent; 0-5% wt. of one or more optional constituents for improving the aesthetic characteristics of the compositions; and, at least 75% wt. of water; wherein the compositions exhibit a viscosity of between about 250 cps to about 1000 cps at 25° C., and, exhibit an acidic pH of less than about 5. The compositions are particularly useful in the cleaning treatment of hard surfaces, particularly lavatory surfaces.

The present invention relates to viscous abrasive hard surface cleaning compositions, particularly adapted for the cleaning of hard surfaces, particularly lavatory surfaces and lavatory appliances, e.g., toilets. More particularly the present invention relates to aqueous abrasive hard surface cleaning compositions particularly adapted for the cleaning treatment of lavatory surfaces, especially lavatory appliances having inclined surfaces, e.g., toilets, urinals, bidets and the like.

While the art is replete with hard surface cleaning compositions which are effective in the cleaning of a variety of stains which are frequently encountered in lavatories and bathrooms, e.g., limescale stains, soap scum stains and organic soils, the effective cleaning of lavatory appliances, e.g., toilets, requires that effective coverage of surfaces intended to be treated with the composition occur in order to ensure that contact between a cleaning composition and the stains present on the surface occur. Without such contact, ineffective cleaning is to be expected. With regard to compositions which are used in the cleaning of toilets, a particular problem is that while it is advantageous to utilize a composition which is viscous in order to provide good coverage and retention on an inclined surface, e.g., the interior of a toilet bowl, in need of a cleaning treatment, the use of such viscous compositions as dispensed from a squeeze bottle is not without problems. Frequently, a user is directed to supply a generally uniform quantity of a cleaning composition to the interior of a toilet bowl, such as by simultaneously squeezing a bottle containing such a composition while expelling its contents out from a nozzle in order to apply it underneath the upper rim of a toilet bowl. While such an operation is effective in the delivery of a quantity of the cleaning composition to the sidewall of a toilet bowl, with prior art compositions it is almost universally observed that as the layer, or lamina of applied liquid slowly descends towards the bottom of the interior of the toilet bowl, the lamina almost always separates into a plurality of discrete downwardly extending regions of the cleaning composition, which once formed form channels through which the applied compositions prefer to flow downwardly leaving parts of the toilet bowl bare and not contacted by the applied composition. In order to ensure good coverage, either reapplication of a further amount of the cleaning composition and/or user intervention, e.g., the use of a toilet brush in order to physically spread the cleaning composition to the uncoated zones or regions is required. Both of these alternatives are directed to overcoming shortcomings of the flow profile of the lamina of falling cleaning composition applied to the toilet bowl but both alternatives are not without their shortcomings. In the case of the former, the need to reapply the cleaning composition is wasteful of the cleaning composition which may have been amply effective if it had been more effective in providing a more even coating of the interior surface of the toilet bowl. In the case of the latter, manual intervention is not favored by consumers in all instances and additionally may cause an uneven layer, or for that matter a layer of a cleaning composition to be applied which is undesirably diluted when a wet toilet brush is used. Such only further detracts from the potential cleaning efficacy of the cleaning composition had it been possible to more effectively apply it to the interior sidewalls of the toilet bowl.

Further, many prior art compositions typically exhibit relatively low viscosities which detract from the retention of a laminar layer of the applied cleaning composition to be retained on the inclined sidewalls of the toilet bowl, or other lavatory appliance, e.g., urinal, bidet, and the like to which the composition has been applied. Such undesirably diminishes the potential for effective antimicrobial treatment of the inclined surfaces to which the composition has been applied.

Additionally, compositions particularly adapted for the cleaning treatment of lavatory surfaces, especially lavatory appliances having inclined surfaces which contain a significant proportion of an abrasive constituent are not widely known. Such is likely due to the fact that it is difficult to produce such compositions wherein the abrasive constituent present does not unduly quickly flocculate to the bottom of a container or flask, thus causing localized non-homogeneities in a composition and unequal suspension of the abrasive constituent, which is typically in the form of particulates. The inclusion of such would be desirable as improving the cleaning efficacy of the compositions.

While compositions are known to the art which provide a cleaning and optionally a disinfecting benefit to hard surfaces and particularly to lavatory appliances there is nonetheless a real and continuing need in the art to provide still further improved compositions which provide an improved cleaning, and desirably also a simultaneous sanitizing or disinfecting benefit to treated hard surfaces. Particularly there is a real need in the art for liquid cleaning compositions useful in the treatment of hard surfaces which feature improved surface coverage when applied from a container, especially a squeeze bottle onto a vertical or inclined hard surface, and which are retained upon the inclined sidewalls of the toilet bowl, or other lavatory appliance.

Accordingly, it is among the aspects of the invention to provide improved cleaning compositions which provide the benefits of good cleaning to a treated hard surface, and especially to provide feature improved surface coverage when applied from a container, especially a squeeze bottle onto a vertical or inclined hard surface, particularly surfaces of a toilet or other lavatory appliance. In preferred embodiments the inventive compositions also provide a useful sanitizing or disinfecting benefit to such treated surfaces.

A yet further aspect of the invention is a readily pourable and readily pumpable cleaning composition which features the benefits described above.

A yet further aspect of the invention is a method for the manufacture of the improved cleaning compositions which feature the benefits described above.

According to a still further aspect of the invention there is provided a method for the cleaning of hard surfaces, particularly lavatory appliances and especially such surfaces and appliance surfaces which are vertical or inclined which method contemplates the application of and the use of the compositions of the present invention to such hard surfaces in order to provide an improved delivery and/or cleaning benefit. In preferred embodiments the method of use of the inventive compositions also provide a useful sanitizing or disinfecting benefit to such treated surfaces.

These and other objects of the invention are disclosed in the following specification.

In a first embodiment the present invention provides aqueous acidic, abrasive hard surface cleaning compositions which comprise (preferably consists essentially of):
about 0.5-3.5% wt. of a thickener system which includes both a colloid forming clay, preferably a montmorillonite clay, and a gum based thickener, preferably xantham gum, wherein the relative weight ratios of the gum based thickener to the colloid forming clay is in the range of from about 5:1 to about 7.75:1, and preferably wherein the amount of the colloid forming clay present in an amount of at least about 0.5% wt., and is not in excess of about 2% wt., and concurrently wherein the amount of gum based thickener present is not in excess of about 0.5% wt.;
about 0.01-2.5% wt. of a surfactant selected from anionic surfactants, nonionic surfactants, and mixtures thereof;
an antimicrobially effective amount of at least one organic acid, preferably present in an amount of from about 2-12% wt., preferably about 2-10% wt., more preferably about 4-8% wt., and especially preferably wherein the at least one organic acid is selected from the group consisting of: citric acid, formic acid, lactic acid, oxalic acid and mixtures thereof;
as an abrasive constituent, pumice, which may be present in an amount of at least about 5% wt.; optionally but preferably an opacifying/tinting constituent, preferably wherein the opacifing constituent comprises or is solely titanium dioxide;
0-5% wt. of one or more optional constituents for improving the aesthetic characteristics of the compositions; and,
at least 75% wt, of water;
wherein the compositions exhibit a viscosity of between about 250 cps to about 1000 cps at 25° C., preferably between about 250 cps to about 500 cps at 25° C. and, exhibit an acidic pH of less than about 5, and preferably a pH in the range of 1-4, particularly preferably between 1.5 and 3.

Particularly preferred compositions of the invention are further characterized in also exhibiting antimicrobial efficacy against gram positive and gram negative microorganisms upon hard surfaces upon which the compositions are applied.

In particularly preferred embodiments the inventive compositions exclude inorganic acids, e.g., hydrochloric acid, sulfuric acid.

In particularly preferred embodiments the inventive compositions exclude added organic solvents, e.g., alcohols, glycols, glycol ethers and the like, excluding the minor amount of organic solvents or hydrotropes which may be present as carriers or solubilizers for a constituent, e.g., a carrier for a fragrance constituent.

In particularly preferred embodiments the inventive compositions exclude cationic surfactants, particularly cationic surfactants which provide an antimicrobial benefit such as those based on cationic quaternary surfactant compounds, e.g. quaternary ammonium chlorides and the like.

The inventive compositions necessarily comprise a thickener system comprising on one or more colloid-forming clays, for example, smectite and/or attapulgite types. Inorganic colloid forming clays tend to provide higher stability in the presence of chlorine and do not thin when subjected to shear.

The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites). Smectites are three-layered clays. There are two distinct classes of smectite-type clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas may vary with the processing to which the clay has been subjected.

Commercially available clays include, for example, montmorillonite (bentonite), volchonskoite, nontronite, beidellite, hectorite, saponite, sauconite and vermiculite. The clays described are available under various trade names such as Gelwhite H NF and

Gelwhite GP from Southern Clay Products. (both montmorillonites); Gelwhite H (described as a montmorillonite, less frequently also referred to as a bentonite); Van Gel O from R. T. Vanderbilt, smectites, laponites and layered silicates from Southern Clay Products. A second type of expandable clay material useful in the instant invention is classified geologically as attapulgite (polygorskite). Attapulgites are magnesium-rich clays having principles of superposition of tetrahedral and octahedral unit cell elements different from the smectites. Like the smectites, attapulgite clays are commercially available. For example, such clays are marketed under the tradename Attagel, i.e. Attagel 40, Attagel 50 and Attagel 150 from BASF AG.

The thickener system of the invention also necessarily comprise at least one gum based thickener. Such gum based thickeners include: exopolysaccharides (also known as biopolymers) such as welan gum, xanthan gum, rhamsan gum, gellan gum, dextran gum, pullulan gum, curdlan gum, and the like; marine gums such as agar, seagel, carrageenan, and the like; plant exudates, such as locust bean gum, gum arabic, gum Karaya, tragacanth, Ghatti, and the like; seed gums such as guar gum, locust bean gum, okra, psyllium, mesquite, and the like; as well as starch-based gums such as ethers, esters, and related derivatized compounds, e.g., gelatins, pectins, agars, carrageenans, locust beans, guars, xanthans, gellans and konjac gums. Particularly preferred is xantham gum, and in preferred embodiments xantham gum is the sole gum based thickener present in the compositions. The gum based thickener may exhibit any number average molecular weight range, such as 1000 to 1,000,000.

Advantageously the thickener system comprises includes both a colloid forming clay, preferably a montmorillonite clay, and a gum based thickener, preferably xantham gum, wherein the relative weight ratios of the gum based thickener to the colloid forming clay is in the range of from about 5:1 to about 7.75:1, and preferably wherein the amount of the colloid forming clay present in an amount of at least about 0.5% wt., and is not in excess of about 2% wt., and concurrently wherein the amount of gum based thickener present is not in excess of about 0.5% wt., based on the total weight of the inventive compositions of which they form a part.

Within the thickener system, the colloid forming clay, preferably a montmorillonite clay, and a gum based thickener, preferably xantham gum, are necessarily present in relative weight ratios of the gum based thickener to the colloid forming clay is in the range of from about 5:1 to about 2.75:1. Particularly preferred ratios are disclosed in one or more of the Examples.

Preferably, further thickener constituents known to the art, especially alginates such as sodium alginate and propyleneglycol alginate, as well as cellulose derivatives, such as the carboxymethylcelluloses, hydroxyalkylcelluloses, and hexamethylpropylcelluloses are expressly excluded from the inventive compositions.

The inventive compositions necessarily 0.01-1.5% wt. of at least one surfactant selected from anionic surfactants, nonionic surfactants, and mixtures thereof.

Generally any anionic surfactant material may be used in the inventive compositions as a detersive surfactant. By way of non-limiting example, suitable anionic surfactants include: alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds comprise a carbon chain containing 12 to 20 carbon atoms.

Preferred anionic surfactants include alkyl sulfates which may be represented by the following general formula:

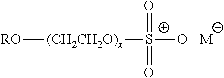

wherein R is an straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium, or is ammonium or substituted ammonium cation, and x is from 0 to about 4. Of these, most preferred are the non-ethoxylated C₁₂-C₁₅ primary and secondary alkyl sulfates, and especially sodium lauryl sulfate.

Further preferred anionic include alkyl sulfonate anionic surfactants which may be represented according to the following general formula:

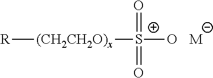

wherein R is an straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium, or is ammonium or substituted ammonium cation, and x is from 0 to about 4. Most preferred are the C₁₂-C₁₅ primary and secondary alkyl sulfates. Of these, most preferred are secondary sodium alkane sulfonate surfactants.

The inventive compositions may include one or more nonionic surfactants. Generally any nonionic surfactant material may be used in the inventive compositions. Practically any hydrophobic compound having a carboxy, hydroxy, amido, or amino group with a free hydrogen attached to the nitrogen can be condensed with an alkylene oxide, especially ethylene oxide or with the polyhydration product thereof, a polyalkylene glycol, especially polyethylene glycol, to form a water soluble or water dispersible nonionic surfactant compound. Exemplary useful nonionic surfactants include primary and secondary linear and branched alcohol alkoxylates, preferably ethoxylates, such as those based on C₆-C₁₈ alcohols which further include an average of from 2 to 80 moles of ethoxylation per mol of alcohol. Such include the Genapol® UD surfactants (ex. Clariant), C10 oxo-alcohol ethoxylates available under the Lutensol® ON tradename (ex BASF), ethoxylated aliphatic alcohols available in the Neodol® surfactant series, as well as under the Tomadol® tradename as well as the Genapol® tradename (ex. Clariant), with the formula RO(CH₂CH₂O)ₙH where R is the primary linear alcohol and n is the total number of moles of ethylene oxide, wherein R is typically between 6 and 22, and n typically a value of between 1 and 16. A further exemplary class of useful nonionic surfactants include polyalkylene oxide condensates of alkyl phenols. These compounds include the condensation products of alkyl phenols having an alkyl group containing from about 6 to 12 carbon atoms in either a straight chain or branched chain configuration with an alkylene oxide, especially an ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like.

A further class of useful nonionic surfactants include alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

The compositions of the present invention expressly exclude a nonionic amine oxide constituent, cationic surfactants, zwitterionic surfactants and amphoteric surfactants.

The inventive compositions include about 0.01-2.5% wt., preferably about 0.1-2% wt. of a surfactant selected from anionic surfactants, nonionic surfactants, and mixtures thereof.

The compositions of the invention are acidic in nature and comprise at least one organic acid in a sufficient amount in order that the compositions of the invention are at a pH of 4 or less, and increasingly preferably, in the order of the following sequence, have a pH of up to about 3.8, 3.5, 3.25, 3.0, 2.75, 2.5, 2.25, 2, 1.75, 1.5, 1.25 and 1. Preferably the inventive compositions exhibit a pH of at least about 1, and increasingly preferably, in order of the following sequence, have a pH of at least about 1, 1.25, 1.5, 1.75, 2, 2.25, 2.5, 2.75 and 3. Particularly preferably the composition exhibits a pH in the range of about 1.5-3.

Exemplary useful organic acids include any known art organic acid which may be found effective in the inventive compositions. Generally useful organic acids are those which include at least one carbon atom, and include at least one carboxyl group (—COOH) in its structure. Preferred are water soluble organic acids which contain from 1 to about 6 carbon atoms, and at least one carboxyl group as noted. Exemplary useful organic acids include: linear aliphatic acids such as formic acid, acetic acid, propionic acid, butyric acid and valeric acid; dicarboxylic acids such as oxalic acid, malonic acid, succinic acid, glutaric acid, adipic acid, pimelic acid, fumaric acid and maleic acid; acidic amino acids such as glutamic acid and aspartic acid; and hydroxy acids such as glycolic acid, lactic acid, hydroxyacrylic acid, alpha-hydroxybutyric acid, glyceric acid, tartronic acid, malic acid, tartaric acid and citric acid, as well as acid salts of these organic acids. Preferred examples of the organic acid to be used in the present invention include linear aliphatic acids such as formic acid, and citric acid, and optionally acetic acid, propionic acid, butyric acid and valeric acid; dicarboxylic acids such as oxalic acid, malonic acid, succinic acid, glutaric acid, adipic acid, pimelic acid, fumaric acid and maleic acid; acidic amino acids such as glutamic acid and aspartic acid; and hydroxy acids such as glycolic acid, lactic acid, hydroxyacrylic acid, alpha-hydroxybutyric acid, glyceric acid, tartronic acid, malic acid, tartaric acid and citric acid, as well as acid salts of these organic acids. Preferred useful organic acids include citric acid, cresylic acid, dodecylbenzene sulfonic acid, phosphoric acid, salicylic acid, sorbic acid, sulfamic acid, acetic acid, benzoic acid, boric acid, capric acid, caproic acid, cyanuric acid, dihydroacetic acid, dimethylsulfamic acid, polyacrylic acid, 2-ethyl-hexanoic acid, fumaric acid, I-glutamic acid, isopropyl sulfamic acid, naphthenic acid, oxalic acid, phosphorous acid, valeric acid, benzene sulfonic acid, xylene sulfonic acid, sulfonic acids, maleic acid, acetic acid, adipic acid, formic acid, lactic acid, butyric acid, gluconic acid, malic acid, tartaric acid, as well as glycolic acid. The organic acids can be used singly or as a mixture of two or more such acids. Most preferably the organic acid is selected from the group consisting of: citric acid, formic acid, lactic acid, oxalic acid and mixtures thereof;

The at least one organic acid present is necessarily present in an antimicrobially effective amount and, preferably is present in an amount of from about 2-12% wt., yet more preferably from about 2-10% wt., more preferably about 4-8% wt. of the compositions of which they form a part.

The inventive compositions necessarily comprise pumice as an abrasive material which is preferably present in amounts of between about 2.5-12% wt., preferably about 5-10% wt. of the inventive compositions of which they form a part. The pumice present has particle sizes which may range from about 1 μm to about 200 μm, preferably between about 50 μm to about 200 μm, and more preferably between about 50 μm and about 100 μm. On particularly advantageous grade of pumice useful in the invention is one having the following particle size distribution: at least 99.5% of the particles pass through a 90 micron mesh (equivalent to US Mesh size #170), at least 94% of the particles pass through a 75 micron mesh (equivalent to US Mesh size #200) and at least about 69% of particles pass through a 45 micron mesh (equivalent to US Mesh size #325). Particularly desirably pumice is the sole abrasive constituent present, however it is contemplated that a co-abrasive constituent may be additionally present. Such a co-abrasive constituent may be one or more further particulate abrasive materials, examples of which include: oxides, carbonates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or talc and mixtures thereof. The particle size of such a co-abrasive constituent, when present, can range from about 1 μm to about 1000 μm, preferably between about 10 μm to about 200 μm, and more preferably between about 10 μm and about 100 μm. It is preferred to use those co-abrasive agents that will not scratch glass or ceramic surfaces. Such abrasive agents include of which carbonates such as calcium carbonate, those based on organic abrasie materials, e.g., comminuted polymer particles, and those based on natural materials are preferred.

The compositions of the invention expressly exclude abrasive materials which comprise byproducts, parts or fractions which are based on, or derived from silica, e.g., silicates such as alkali metasilicates, as well as quartzes, in amounts of 5% wt. or more, an in order of increasing preference: about 4.5% wt., 4% wt., 3.5% wt., 3% wt., 2.5% wt., 2% wt., 1.5% wt., 1% wt. 0.75% wt., 0.5% wt., 0.25% wt., based on the weight or mass of the pumice composition present in the inventive compositions. For example, minor amounts of such materials may be tolerated in the inventive compositions as impurities of other constituents, e.g., colloid forming clays which may be mined and include minor amounts of such excluded abrasive materials as a byproduct of processing or an inherent naturally occurring impurity. Most preferably the compositions of the invention expressly exclude abrasive materials based on, or derived from silica, e.g., silicates such as alkali metasilicates, as well as quartzes which are intentionally added as a constituent.

The inventive compositions optionally but preferably an opacifying/tinting constituent, preferably wherein the opacifing/tinting constituent comprises or is solely titanium dioxide. Further opacifying compositions which may be used include one or more of: gypsum, pigment based colorants, and the like. When present such are advantageously present in amounts of up to about 1.2% wt., preferably in amounts of about 0.01-1% wt. of the inventive compositions.

The inventive compositions may include minor amounts of, typically about 0-5% wt. of one or more optional constituents for improving the aesthetic characteristics of the invention. Such further optical constituents may for example include: fragrances, dyestuffs, pH adjusting agents and pH buffers including organic and inorganic salts, optical brighteners, hydrotropes (particularly as a solubilizing agent for a fragrance constituent) anti-oxidants, preservatives, and anti-corrosion agents and the like. Such may be present in any effective amounts, which cumulatively typically do not exceed about 5% wt. of the inventive compositions.

As the compositions are largely aqueous, water is the major constituent present and constitutes at least 75% wt, preferably at least about 80% wt. of water. The water may be from any suitable source including available tap water such as from a municipal water supply, reservoir or well, as well as deionized, demineralized or distilled water.

The compositions of the invention are viscous, and exhibit a viscosity of between about 250 to about 1000 cps at 25° C., preferably in the range of about 300 to 750 cps at said temperature.

The inventive composition can be provided and stored in a non-deformable bottle but more preferably is provided in a squeezable container, such as a tube or deformable bottle fitted with a flow directing nozzle which provides for easy dispensing of the composition by the consumer directly onto surfaces.

The inventive compositions are particularly adapted for the cleaning treatment of lavatory surfaces, especially lavatory appliances having inclined surfaces, and are readily effectively applied it to the interior sidewalls of the toilet bowl. The viscous nature of the composition provides excellent and generally uniform coverage to the inclined surfaces to which it has been applied. Advantageously such an applied composition forms a lamina which coats the inclined surface and due to excellent retention on such inclined surface, the composition may be used to very effectively clean and impart an antimicrobial benefit to the coated inclined surface. The pumice of the compositions also provide for an abrasive benefit for improved cleaning of the coated inclined surface, which may optionally be manually cleaned by a user, e.g., with a toilet brush. Alternately the presence of the pumice also imparts a cleaning benefit to the interior sanitary appliance even where no manual cleaning operation is performed as it is believed that entrainment of the pumice in the flush water circulating in the inner regions of the toilet bowl or other lavatory appliance provides a physical abrasion effect to the surfaces contacted by the flush water.

It has been surprisingly observed that preferred compositions of the invention not only provide excellent cleaning and antimicrobial benefits to treated surfaces, but also that the compositions are storage stable and do not suffer from separation into two or more phases and/or undergo undesired amounts of flocculation of the pumice present in the compositions, even under long term storage at elevated temperatures. Such is believed attributable to the specific amounts of the thickener constituents present, their respective ratios, and the controlled amounts of the remaining constituents, including the limited amounts of specified surfactants, and concurrently the absence of organic solvents.

The following examples exhibit exemplary and preferred formulations of the invention. It is to be understood that these examples are provided by way of illustration only and that further useful formulations falling within the scope of the present invention and the claims may be readily produced by one skilled in the art without deviating from the scope and spirit of the invention.

### EXAMPLES

Formulations according to the invention were produced by mixing the constituents outlined in Table 1 by adding the individual constituents into a beaker of tap water from a local municipal water supply source (in Montvale, N.J., USA) at room temperature which was stirred with a conventional magnetic stirring rod. Stirring continued until each of the formulations were homogenous in appearance. It is to be noted that the constituents might be added in any order, but it is preferred that a major proportion of water be the initial constituent provided to a mixing vessel or apparatus as it is the major constituent and addition of the further constituents thereto is convenient.

Still more preferably to a major part of the water which is maintained under constant stirring are added the constituents are added with a sufficient time lapse between the addition of each constituent in order to ensure that the immediately prior added constituent has been homogenously blended. After the addition of the final constituent, mixing continued for 5-60 minutes to ensure homogenous blending.

According to a preferred process for the production of the inventive compositions, a first premixture of about 25% of the total water at approximately 20° C. was first mixed at room temperature (approx. 20° C.) with a magnetic stirring rod (or shaft driven propeller) wherein first the total amount of titanium dioxide was added and allowed to stir several minutes until a uniform mixture was produced and thereafter the xanthan gum was slowly added under stirring conditions to this beaker, and allowed to stir for 30-180 minutes until the contents of this first beaker were homogenous.

To a second beaker was added the remaining balance of water at 20° C., to which was provided a shaft driven paddle propeller and under stirring conditions was added in sequence premeasured amounts of: citric acid (when present in a specific composition); the colloid forming clay; pumice; the first premixture described above; forming acid and/or the remaining organic acid(s) not previously added, (when present in a specific composition); surfactant(s); and finally any dyes, colorants and/or fragrances present. Following the addition of any constituent, the contents of the second beaker were stirred for a sufficient duration to ensure homogenous blending of the previously added constituent. Following the addition of the final constituent, stirring continued for at least 10 minutes to ensure the formation of a homogenous mixture after which the shaft driven paddle propeller was withdrawn from the second beaker which contained the inventive composition thus formed.

These compositions according to the examples are indicated on Table 1 by the letter “E” followed by a digit.

Certain compositions which are considered to be “comparative examples” were also produced in the manner described above and using the same constituents, and these comparative examples are indicated on Table 2, following. These compositions according to the comparative examples are indicated by the letter “C” followed by a digit.

TABLE 1

| | E1 | E2 | E3 | E4 | E5 | E6 | E7 | E8 |
|---|---|---|---|---|---|---|---|---|
| xanthan gum | 0.3 | 0.35 | 0.4 | 0.35 | 0.35 | 0.3 | 0.3 | 0.3 |
| montmorillonite clay | 1.5 | 1.25 | 1.5 | 1.4 | 1.4 | 1.5 | 1.5 | 1.5 |
| sodium lauryl sulfate | — | 0.5 | — | 0.5 | 0.5 | — | — | — |
| surfactant | | | | | | | | |
| ethoxylated nonionic | — | — | 1 | — | — | — | — | — |
| surfactant 1 | | | | | | | | |
| ethoxylated nonionic | — | — | — | — | — | 0.75 | 0.75 | 1 |
| surfactant 2 | | | | | | | | |
| formic acid (85%) | 3 | 3 | — | 2.5 | 8 | — | — | |
| citric acid | 3.5 | 3.5 | 3 | 3.25 | — | 7 | 7 | 7 |
| TiO2 | 0.2 | 0.4 | 0.8 | 0.4 | 0.4 | 0.8 | 0.8 | 0.8 |
| pumice | 5 | 5 | 10 | 8 | 8 | 10 | 10 | 5 |
| micro beads | — | — | — | — | — | 1 | — | — |
| dye (1%) | 0.2 | 1.5 | 0.5 | 0.002 | 0.002 | 0.15 | 0.15 | 0.15 |
| fragrance | 0.2 | 0.15 | 0.15 | 0.15 | 0.15 | 0.15 | 0.15 | 0.15 |
| water | 84.6 | 84.3 | 82.65 | 83.45 | 81.2 | 78.35 | 79.35 | 84.1 |
| pH | 2.3 | 2.3 | 2.3 | 2.3 | 2.2 | 2.3 | 2.3 | 2.85 |
| viscosity (cps at 25° C.) | 251 | 411 | 458 | 351 | 411 | 451 | 451 | 322 |

TABLE 2

| | C1 | C2 | C3 | C4 | C5 | C6 | C7 | C8 | C9 |
|---|---|---|---|---|---|---|---|---|---|
| xanthan gum | — | — | — | — | — | — | 0.4 | 0.4 | 0.4 |
| montmorillonite clay | 2 | 1.75 | 2.0 | 4 | 1.75 | 2.25 | 1.5 | 1.5 | 1.5 |
| cellulose thickener | 0.35 | 0.4 | 0.35 | — | — | — | 0.1 | 0.1 | — |
| sodium lauryl sulfate | — | — | — | — | — | — | 3 | 0.5 | — |
| surfactant | | | | | | | | | |
| ethoxylated nonionic | — | — | — | — | — | — | — | — | 3 |
| surfactant 2 | | | | | | | | | |
| amine oxide surfactant | 2 | 2 | — | 1 | 0.5 | 1 | — | — | — |
| quaternary ammonium | 2 | 2 | — | — | — | 2 | — | — | 1.53 |
| surfactant 1 | | | | | | | | | |
| quaternary ammonium | — | — | 2 | 1.8 | 2 | — | — | — | — |
| surfactant 2 | | | | | | | | | |
| oxalic acid | — | — | — | — | — | — | — | — | 2.5 |
| lactic acid (80%) | — | — | — | — | — | — | 3 | 3 | — |
| formic acid (85%) | — | — | — | — | — | — | — | — | 1.5 |
| citric acid | 3 | 3 | 3 | 2 | 3 | 2.25 | 5 | 5 | — |
| sodium hydroxide (25%) | 0.5 | 0.5 | 1 | — | — | — | 1.95 | 1.95 | — |
| TiO2 | 0.4 | 0.4 | 0.4 | — | 0.8 | — | 0.8 | 0.8 | 0.8 |
| polyurethane abrasive | 5 | 6 | 7 | — | — | — | — | — | — |
| pumice | — | — | — | 5 | 10 | 12.6 | 10 | 10 | 12 |
| dye (1%) | 1 | — | 0.65 | 0.5 | 0.5 | 0.5 | 0.15 | 0.15 | 0.1 |
| fragrance | 0.2 | 1.2 | 0.2 | 0.15 | 0.15 | 0.15 | 0.15 | 0.15 | 0.2 |
| water | 83.6 | 82.75 | 82.4 | 85.5 | 81.3 | 79.25 | 73.95 | 76.45 | 76.47 |
| pH | 3.2 | 3.4 | 2.3 | n.t. | n.t. | n.t. | 3.1 | 3.13 | n.t. |
| viscosity (cps at 25° C.) | 321 | 401 | 512 | n.t. | n.t. | n.t. | 757.9 | 610.9 | n.t. |

“n.t.” indicates that the composition was not tested

The following table identifies the individual constituents described in the foregoing examples. The constituents were used “as supplied” from their respective suppliers and may constitute less than 100% wt. “actives” in which case the amount is indicated in parenthesis, or may have been supplied as constituting 100% wt. “active” of the named compound, as indicated in the following Table.

| Constituent: | Identity and/or source |
|---|---|
| xanthan gum | supplied as Kelzan ASXT (ex. CP Kelco) |
| | (100% wt. actives) |
| montmorillonite clay | supplied as Gelwhite H (ex. Southern Clay |
| | Products) (100% wt. actives) |
| cellulose thickener | supplied as Cellosize QP 100MH (ex. Dow |
| | Chem. Co.) (98-100% wt. actives) |
| sodium lauryl sulfate | supplied as Calfoam ES 302 (ex. Pilot Chemical |
| surfactant | Co.), (30% wt. actives) or supplied as Empicol |
| | LX 28/Z (ex. Huntsman Chemical Co.) |
| | (28% wt. actives) |
| ethoxylated nonionic | supplied as Neodol 91-6 (ex. Shell Co.) |
| surfactant 1 | (98-100% wt. actives) |
| ethoxylated nonionic | supplied as Tomadol 25-9 (ex. Air Products Co.) |
| surfactant 2 | (98-100% wt. actives) |
| amine oxide surfactant | supplied as Ammonyx LO (ex. Stepan Co.) |
| | (30% wt. actives) |
| quaternary ammonium | supplied as Bardac 208M (ex. Lonza) (80% wt. |
| surfactant 1 | actives) |
| quaternary ammonium | supplied as Bardac 2270 (ex. Lonza) |
| surfactant 2 | (70% wt. actives) |
| formic acid (85%) | supplied as laboratory grade formic acid (85% wt. |
| | actives) |
| citric acid | supplied as laboratory grade, anhydrous citric acid |
| | (100% wt. actives) |
| sodium hydroxide | 25% wt. aqueous sodium hydroxide solution |
| (25%) | |
| TiO2 | supplied as anyhydrous titanium dioxide |
| | (100% wt. actives) |
| polyurethane abrasive | polyurethane abrasive powder |
| pumice | particulate pumice abrasive, having an average |
| | particle size of less than 90 microns (ex. Hess |
| | Pumice Products) |
| dye | 1% wt. aqueous solution of a proprietary dyestuff |
| | composition |
| fragrance | proprietary composition of its supplier |
| water | municipal water supply |

With reference to the comparative examples reported on Table 2 it was observed that: C1, C2, C3 failed to remain stable during storage at elevated temperatures (50° C.) and was observed to separate into two visible phases; C4 failed to remain stable during storage at room temperature (20° C.) and was observed to separate into two visible phases within 24 hours; C5. C6 failed to remain stable during storage at elevated temperatures (50° C.) and was observed to separate into two visible phases within 24 hours; C7, C8 failed antimicrobial efficacy testing; C9 was observed to undergo a reaction between the xanthan gum and the cationic quaternary ammonium surfactant present, indicative of incompatibility of these constituents.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An aqueous acidic, abrasive hard surface cleaning composition comprising:
about 0.5-3.5% wt. of a thickener system which includes both a colloid forming clay, and a gum based thickener wherein the relative weight ratios of the gum based thickener to the colloid forming clay is in the range of from about 5:1 to about 7.75:1;
about 0.01-2.5% wt. of a surfactant selected from anionic surfactants, nonionic surfactants, and mixtures thereof;
an antimicrobially effective amount of at least one organic acid present in an amount of from about 2-12% wt.,;
as an abrasive constituent, pumice, which may be present in an amount of at least about 5% wt,;
optionally but preferably an opacifying/tinting constituent;
0-5% wt. of one or more optional constituents for improving the aesthetic characteristics of the compositions; and,
at least 75% wt of water;
wherein the compositions exhibit a viscosity of between about 250 cps to about 1000 cps at 25° C., and, exhibit an acidic pH of less than about 5.

2. An aqueous acidic, abrasive hard surface cleaning composition according to claim 1, which is further characterized in that the composition exhibits antimicrobial efficacy against gram positive and gram negative microorganisms upon hard surfaces upon which the compositions are applied.

3. An aqueous acidic, abrasive hard surface cleaning composition according to claim 1, wherein the amount of the colloid forming clay present in an amount of at least about 0.5% wt., and is not in excess of about 2% wt., and concurrently wherein the amount of gum based thickener present is not in excess of about 0.5% wt.

4. An aqueous acidic, abrasive hard surface cleaning composition according to claim 1 comprising about 2-10% wt. organic acid.

5. An aqueous acidic, abrasive hard surface cleaning composition according to claim 1 wherein the pumice is present in an amount of between about 5-12% wt.

6. An aqueous acidic, abrasive hard surface cleaning composition according to claim 1 having a pH in the range of 1-4.

7. An aqueous acidic, abrasive hard surface cleaning composition according to claim 1 characterized in that inorganic acids are excluded.

8. An aqueous acidic, abrasive hard surface cleaning composition according to claim 1 characterized in that added organic solvents are excluded.

9. An aqueous acidic, abrasive hard surface cleaning composition according to claim 1 characterized in that cationic surfactants which provide an antimicrobial benefit are excluded.

10. A method for cleaning hard surfaces, particularly lavatory appliances and especially such surfaces and appliance surfaces which are vertical or inclined which method includes the step of: applying an aqueous acidic, abrasive hard surface cleaning composition according to claim 1 to such hard surfaces in order to provide an improved delivery and/or cleaning benefit.

11. A composition according to claim 1, wherein the organic acid present is selected from the group consisting of: citric acid, formic acid, lactic acid, oxalic acid and mixtures thereof.

12. An aqueous acidic, abrasive hard surface cleaning composition comprising:
about 0.5-3.5% wt. of a thickener system which includes both a montmorillonite clay, and xantham gum, wherein the relative weight ratios of the xantham gum to the colloid forming clay is in the range of from about 5:1 to about 7.75:1;
about 0.01-2.5% wt. of a surfactant selected from anionic surfactants, nonionic surfactants, and mixtures thereof;
an antimicrobially effective amount of at least one organic acid present in an amount of from about 2-12% wt., wherein the at least one organic acid is selected from the group consisting of: citric acid, formic acid, lactic acid, oxalic acid and mixtures thereof;
at least about 5% wt. of pumice;
an opacifying/tinting constituent, wherein the opacifing constituent comprises or is solely titanium dioxide;
0-5% wt. of one or more optional constituents for improving the aesthetic characteristics of the compositions; and,
at least 75% wt, of water;
wherein the compositions exhibit a viscosity of between about 250 cps to about 1000 cps at 25° C., and, exhibit a pH in the range of 1-4.

13. An aqueous acidic, abrasive hard surface cleaning composition according to claim 12, which is further characterized in that the composition exhibits antimicrobial efficacy against gram positive and gram negative microorganisms upon hard surfaces upon which the compositions are applied.

14. An aqueous acidic, abrasive hard surface cleaning composition according to claim 12, wherein the amount of the colloid forming clay present in an amount of at least about 0.5% wt., and is not in excess of about 2% wt., and concurrently wherein the amount of gum based thickener present is not in excess of about 0.5% wt.

15. An aqueous acidic, abrasive hard surface cleaning composition according to claim 12, comprising about 2-10% wt. organic acid.

16. An aqueous acidic, abrasive hard surface cleaning composition according to claim 12, wherein the pumice is present in an amount of between about 5-12% wt.

17. An aqueous acidic, abrasive hard surface cleaning composition according to claim 1, having a pH in the range of 1-4.

18. An aqueous acidic, abrasive hard surface cleaning composition according to claim 12, characterized in that inorganic acids are excluded.

19. An aqueous acidic, abrasive hard surface cleaning composition according to 12, characterized in that added organic solvents are excluded.

20. An aqueous acidic, abrasive hard surface cleaning composition according to claim 1, characterized in that cationic surfactants which provide an antimicrobial benefit are excluded.
